(19) United States
(12) Patent Application Publication
(10) Pub. No.: US 2026/0252390 A1
(43) Pub. Date: Aug. 27, 2026

(54) RETRIEVAL OF APPLICATION DATA FROM DATA SOURCES

(71) Applicant: International Business Machines Corporation, Armonk, NY (US)

(72) Inventors: Ying Mo, San Jose, CA (US); Xiao Guang Luo, Beijing (CN); Yue Chen, Beijing (CN); Qi Huang, Chengdu (CN); Ying Yu, BEIJING (CN); Yuan Yuan Jia, BEIJING (CN); Hui Jun Song, BEIJING (CN)

(21) Appl. No.: 19/060,699

(22) Filed: Feb. 23, 2025

(51) Int. Cl. G06F 9/50; G06F 9/54

(52) U.S. Cl. CPC G06F 9/5016; G06F 9/544

(57) ABSTRACT

Retrieval of application data from data sources includes receiving a request from a user device to obtain application data associated with an application. The user device, the application data, and the computer are associated with at least a computational environment. The log data is obtained. The log data is indicative of a set of operations executed on at least one portion of the application data. The status data associated with the application data is determined based on the log data. The modified at least one portion of the application data is retrieved based on a determination that the status data is indicative of a modified state of the at least one portion of the application data. A storage environment is updated with the modified at least one portion of the application data. The modified at least one portion of the application data is transmitted to the user device.

### BACKGROUND

The disclosure relates generally to the field of data management, more particularly, to data retrieval.

With the advancement of computing technologies, the scalability and complexity of computing systems (such as mobile devices, personal computers, and the like) have increased. The increased scalability and the increased complexity allow for the deployment of various applications (such as software as service (SaaS) applications, mobile applications, web applications, and the like). Additionally, the increased scalability and the increased complexity allow users of various applications to interact simultaneously, thereby leading to the generation of a large volume of data (such as image data, audio data, text data, and the like) generated by the users. To that end, various computational environments (such as customer relationship platforms, cloud platforms, and the like) have been widely utilized to manage the large volume of data associated with the various applications. Specifically, various computational environments are configured to execute various operations for managing the large volume of data. Examples of one or more operations include data retrieval operations, data storage operations, data security operations, data transmission operations, and data rendering operations.

However, the execution of one or more operations includes computationally expensive input/output operations that lead to a decrease in the performance of various computational environments. Hence, there is a need to increase the performance of various computational environments for improved management of the large volume of data associated with the various applications.

### SUMMARY

In an embodiment of the disclosure, a computer-implemented method for retrieval of application data from data sources is provided. The computer-implemented method includes receiving, by a computer, a request from a user device to obtain application data associated with an application. The user device, the application data, and the computer are associated with at least a computational environment. The computer-implemented method includes obtaining, by the computer, log data indicative of a set of operations executed on at least one portion of the application data. The computer-implemented method includes determining, by the computer, status data associated with the application data based on the log data. The computer-implemented method includes retrieving, by the computer, modified at least one portion of the application data based on a determination that the status data is indicative of a modified state of the at least one portion of the application data. The modified state of the at least one portion of the application data indicates that the at least one portion of the application data is modified within the computational environment. The at least one portion of the application data is modified based on the set of operations executed on the at least one portion of the application data. The computer-implemented method includes updating, by the computer, a storage environment with the modified at least one portion of the application data. The computer-implemented method includes transmitting, by the computer, the modified at least one portion of the application data to the user device.

In various embodiments of the disclosure, a computer system for retrieval of application data from data sources is provided. The computer system includes a processor set, one or more computer-readable storage media, and program instructions stored on the one or more computer-readable storage media. The program instructions are executable by the processor set to cause the processor set to receive a request from a user device to obtain application data associated with an application. The user device, the application data, and the computer are associated with at least a computational environment. The program instructions further cause the processor set to obtain log data indicative of a set of operations executed on at least one portion of the application data. The program instructions further cause the processor set to determine status data associated with the application data based on the log data. The program instructions further cause the processor set to retrieve modified at least one portion of the application data based on a determination that the status data is indicative of a modified state of the at least one portion of the application data. The modified state of the at least one portion of the application data indicates that the at least one portion of the application data is modified within the computational environment. The at least one portion of the application data is modified based on the set of operations executed on the at least one portion of the application data. The program instructions further cause the processor set to update a storage environment with the modified at least one portion of the application data. The program instructions further cause the processor set to transmit the modified at least one portion of the application data to the user device. The program instructions further cause the processor set to render the modified at least one portion of the application data.

In various embodiments of the disclosure, a computer program product for retrieval of application data from data sources is provided.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for retrieval of application data from data sources, in accordance with an embodiment of the disclosure;

FIG. 2 is a diagram that illustrates an environment for retrieval of application data from data sources, in accordance with an embodiment of the disclosure;

FIG. 3A is a diagram that illustrates first exemplary operations retrieval of application data from data sources, in accordance with an embodiment of the disclosure;

FIG. 3B is a diagram that illustrates second exemplary operations for retrieval of application data from data sources, in accordance with an embodiment of the disclosure;

FIG. 4A, FIG. 4B, and FIG. 4C collectively is a diagram that illustrates third exemplary operations for retrieval of application data from data sources, in accordance with an embodiment of the disclosure;

FIG. 5 is a diagram that illustrates a first flowchart of a method for retrieval of application data from data sources, in accordance with an embodiment of the disclosure; and

FIG. 6 is a diagram that illustrates a second flowchart of a method for retrieval of application data from data sources, in accordance with an embodiment of the disclosure.

### DETAILED DESCRIPTION

With the advancement of computing technologies, the scalability and complexity of computing systems (such as mobile devices, personal computers, and the like) have increased. The increased scalability and the increased complexity allow for the deployment of various applications (such as software as service (SaaS) applications, mobile applications, web applications, and the like). Additionally, the increased scalability and the increased complexity allow users of various applications to interact simultaneously, thereby leading to the generation of a large volume of data (such as image data, audio data, text data, and the like) generated by the users. To that end, various computational environments (such as customer relationship platforms, cloud platforms, and the like) have been widely utilized to manage the large volume of data associated with the various applications. Specifically, various computational environments are configured to execute various operations for managing the large volume of data. Examples of the one or more operations include data retrieval operations, data storage operations, data security operations, data transmission operations, and data rendering operations.

However, the execution of the one or more operations includes computationally expensive input/output operations that lead to a decrease in the performance of various computational environments. Additionally, there is a need for high processing power and a large amount of storage for the execution of the input/output operations. Hence, there is a need to increase the performance of various computational environments for improved management of the large volume of data associated with the various applications.

To that end, storage environments (such as cache memory) have been widely utilized to increase the performance of computational environments. A storage environment corresponds to a memory that is located in a set of processor chip packages (such as integrated circuit chips) associated with a user device of a user. The storage environment is configured to store the cache data identical to at least one portion of application data associated with an application stored within a computational environment. Further, a computer system may obtain the cache data directly from the storage environment based on a request for the application data, thereby reducing the number of requests for retrieval of the application data from the computational environment.

For example, the utilization of a pooling process for storing the cache data within the storage environment is challenging. Specifically, traditional storage environments utilize the pooling process for storing the cache data identical to the at least one portion of the application data. The pooling process includes a transmission of one or more data requests to the computational environments for retrieval of the at least one portion of the application data. Additionally, the storage environment is configured to iteratively execute the pooling process for updating the cache data with respect to a potential or an actual modification to the at least one portion of the application data. However, the iterative execution of the pooling process leads to an increase in the consumption of computational resources (such as memory, processing power, and the like) associated with the computational environment. For example, the computational environment may halt various operations to transmit the at least one portion of the application data based on the one or more data requests. The halting of the various operations may further decrease the performance of the computational environment. In an additional example, a decrease in a frequency of the pooling process may increase a transmission of outdated application data from the storage environment to the user at a time period. The outdated application data is different from the application data that is stored within the computational environment at the time period.

In an embodiment of the disclosure, the computer system may receive the request from the user device to obtain the application data associated with the application. The user device, the application data, and the computer system are associated with at least the computational environment. For example, the application data is being stored on the computer system. In an additional example, the application data is stored on an external computing device or a database without departing from the scope of the disclosure. The application data is associated with one or more processes of the application. Examples of the one or more processes include, but are not limited to, data retrieval processes, data validation processes, data storage processes, data rendering processes, and data transmitting processes. The application data includes, but is not limited to, a set of texts associated with the one or more processes, a set of images associated with the one or more processes, a set of audios associated with the one or more processes, a set of videos associated with the one or more processes, and the like. In an embodiment of the disclosure, the computer system may receive the request to obtain the at least one portion of the application data. For example, the at least one portion of the application data corresponds to a text of the set of texts associated with the one or more processes. In an additional example, the at least one portion of the application data corresponds to an audio of the set of audios.

The computer system may obtain log data indicative of a set of operations (such as a data update operation, a data read operation, a data delete operation, and the like) executed on the at least one portion of the application data. The log data includes a timestamp associated with each operation of the set of operations, a type associated with each operation of the set of operations, an identifier associated with each operation of the set of operations, a result associated with each operation of the set of operations, or any combination thereof. Additionally, the log data includes an identifier of an entity of a set of entities associated with the set of operations, a type of the entity of the set of entities, or any combination thereof.

For example, a timestamp (denoted as eventTime) associated with an operation (denoted as action) of the set of operations is 2014-01 17T23:23:38.109989+0000, the operation corresponds to the data update operation (denoted as update), a type (denoted as type) associated with the operation is activity, an identifier (denoted as id) of an entity associated with the operation is tenant:a80dc5ee-be83-48ad-ad5e6577f2217637, a result (denoted as outcome) associated with the operation is success, and a type (denoted as type) of the entity associated with the operation is tenant/tenant. The log data can be defined as:

{
“type”: “activity”,
“action”: “update”,
“outcome”: “success”,
“eventTime”: “2014-01-
17T23:23:38.109989+0000”,
“target”: {
“id”: “tenant:a80dc5ee-be83-48ad-ad5e6577f2217637”,
“type”: “tenant/tenant”
}

The computer system may determine status data associated with the application data based on the log data. In an embodiment of the disclosure, the status data corresponds to a modified state value (such as 1, modified, and the like) that is indicative of a modified state of the at least one portion of the application data. The modified state of the at least one portion of the application data indicates that the at least one portion of the application data is modified within the computational environment. In various embodiments of the disclosure, the status data corresponds to an unmodified state value (such as 0, unmodified) that is indicative of an unmodified state of the at least one portion of the application data.

The utilization of the log data allows the computer system to determine the status data without transmitting the one or more data requests to the computational environment, thereby mitigating the increase in the consumption of the computational resources associated with the computational environment. Specifically, the computer system may determine an association of the executed set of operations with the at least one portion of the application data based on the log data. Further, the computer system may determine status data based on the determined association between the executed set of operations and the at least one portion of the application data. For example, the computer system may determine that the action (the data update operation) updates the at least one portion of the application data. The computer system may compare an identifier of the data update operation with a set of action identifiers. Each operation of the corresponding action identifier of the set of action identifiers is configured to update the at least one portion of the application data. Further, the computer system may determine the status data corresponding to the modified state value based on the determination that the identifier of the data update operation is present within the set of action identifiers.

Further, the computer system may retrieve modified at least one portion of the application data based on the determination that the status data in indicative of the modified state of the at least one portion of the application data. Additionally, the computer system may update a storage environment with the modified at least one portion of the application data. The determination of the status data allows the computer system to determine the correct time period for the updating of the storage environment, thereby reducing the likelihood of the transmission of outdated application data to the user. Moreover, the computer system may transmit the modified at least one portion of the application data to the user device.

In an alternative embodiment of the disclosure, the computer system may retrieve the cache data from the storage environment based on a determination that status data is indicative of the unmodified state of the at least one portion of the application data. In an embodiment of the disclosure, the computer system may determine that the status data corresponds to the unmodified state value based on the association between the executed set of operations and the at least one portion of the application data. In an additional example, the computer system may determine that the at least one portion of the application data is unmodified based on the execution of an action (the data read operation). The computer system may compare an identifier of the data receive operation with the set of action identifiers. Further, the computer system may determine the status data corresponding to the unmodified state value based on the determination that the identifier of the data receive operation is present within the set of action identifiers.

In an embodiment of the disclosure, a computer-implemented method for retrieval of application data from data sources is provided. The computer-implemented method includes receiving, by a computer, a request from a user device to obtain application data associated with an application. The user device, the application data, and the computer are associated with at least a computational environment. The computer-implemented method includes obtaining, by the computer, log data indicative of a set of operations executed on at least one portion of the application data. The computer-implemented method includes determining, by the computer, status data associated with the application data based on the log data. The computer-implemented method includes retrieving, by the computer, modified at least one portion of the application data based on a determination that the status data is indicative of a modified state of the at least one portion of the application data. The modified state of the at least one portion of the application data indicates that the at least one portion of the application data is modified within the computational environment. The at least one portion of the application data is modified based on the set of operations executed on the at least one portion of the application data. The computer-implemented method includes updating, by the computer, a storage environment with the modified at least one portion of the application data. The computer-implemented method includes transmitting, by the computer, the modified at least one portion of the application data to the user device.

In various embodiments of the disclosure, the computer-implemented method further includes a first identifier associated with the computational environment based on the determination that the status data is indicative of the modified state of the at least one portion of the application data. The computer-implemented method further includes generating, by the computer, a first set of instructions based on the first identifier. The first set of instructions is generated to retrieve the modified at least one portion of the application data. The computer-implemented method further includes executing, by the computer, the generated first set of instructions. The computer-implemented method further includes retrieving, by the computer, the modified at least one portion of the application data from the computational environment based on the execution of the generated first set of instructions.

In various embodiments of the disclosure, the computer-implemented method further includes determining, by the computer, that the status data is indicative of an absence of cache data within the storage environment. The cache data is identical to the at least one portion of the application data. The computer-implemented method further includes retrieving, by the computer, the at least one portion of the application data from the computational environment based on the determination that the status data is indicative of the absence of the cache data within the storage environment. The computer-implemented method further includes transmitting, by the computer, the retrieved at least one portion of the application data to the user device.

In various embodiments of the disclosure, the computer-implemented method further includes determining, by the computer, a second identifier associated with the computational environment based on the determination that the status data is indicative of the absence of the cache data within the storage environment. The computer-implemented method further includes generating, by the computer, a second set of instructions based on the second identifier. The second set of instructions is generated to retrieve the at least one portion of the application data. The computer-implemented method further includes executing, by the computer, the generated second set of instructions. The computer-implemented method further includes retrieving, by the computer, the at least one portion of the application data from the computational environment based on the execution of the generated second set of instructions.

In various embodiments of the disclosure, the computer-implemented method further includes generating, by the computer, the cache data identical to the at least one portion of the application data, based on the retrieval of the at least one portion of the application data from the computational environment. The computer-implemented method further includes storing, by the computer, the generated cache data within the storage environment.

In various embodiments of the disclosure, the computer-implemented method further includes updating, by the computer, the status data based on the generation of the cache data. The updated status data is indicative of an unmodified state of the at least one portion of the application data within the computational environment. Further, the unmodified state of the at least one portion of the application data indicates that the at least one portion of the application data is unmodified within the computational environment based on the set of operations executed on the at least one portion of the application data. The computer-implemented method further includes outputting, by the computer, the updated status data.

In various embodiments of the disclosure, the computer-implemented method further includes determining, by the computer, that the status data is indicative of an unmodified state of the at least one portion of the application data within the computational environment. The computer-implemented method further includes retrieving, by the computer, cache data identical to the at least one portion of the application data from the storage environment, based on the determination that the status data is indicative of the unmodified state of the at least one portion of the application data. The computer-implemented method further includes transmitting, by the computer, the cache data to the user device.

In various embodiments of the disclosure, the computer-implemented method further includes determining, by the computer, an identifier associated with the storage environment based on the determination that the status data is indicative of the unmodified state of the at least one portion of the application data within the computational environment. The computer-implemented method further includes generating, by the computer, a third set of instructions based on the identifier associated with the storage environment. The computer-implemented method further includes executing, by the computer, the generated third set of instructions. The computer-implemented method further includes retrieving, by the computer, the cache data identical to the at least one portion of the application data from the storage environment based on the execution of the generated third set of instructions.

In various embodiments of the disclosure, the computer-implemented method further includes obtaining, by the computer, the application data of the application. The application data includes at least application programming interface (API) data associated with a set of APIs of the application. The computer-implemented method further includes obtaining, by the computer, the log data associated with the set of operations based on the API data. The computer-implemented method further includes determining, by the computer, map data indicative of at least an association between at least one API of the set of APIs and at least one operation of the set of operations, based on the log data. The computer-implemented method further includes determining, by the computer, the status data based on the map data. The computer-implemented method further includes outputting, by the computer, the status data.

In various embodiments of the disclosure, the log data includes at least a timestamp associated with each operation of the set of operations, a type associated with each operation of the set of operations, an identifier associated with each operation of the set of operations, and a result associated with each operation of the set of operations.

In various embodiments of the disclosure, a computer system for retrieval of application data from data sources is provided. The computer system includes a processor set, one or more computer-readable storage media, and program instructions stored on the one or more computer-readable storage media. The program instructions are executable by the processor set to cause the processor set to receive a request from a user device to obtain application data associated with an application. The user device, the application data, and a computer are associated with at least a computational environment. The program instructions further cause the processor set to obtain log data indicative of a set of operations executed on at least one portion of the application data. The program instructions further cause the processor set to determine status data associated with the application data based on the log data. The program instructions further cause the processor set to retrieve modified at least one portion of the application data based on a determination that the status data is indicative of a modified state of the at least one portion of the application data. The modified state of the at least one portion of the application data indicates that the at least one portion of the application data is modified within the computational environment. The at least one portion of the application data is modified based on the set of operations executed on the at least one portion of the application data. The program instructions further cause the processor set to update a storage environment with the modified at least one portion of the application data. The program instructions further cause the processor set to transmit the modified at least one portion of the application data to the user device. The program instructions further cause the processor set to render the modified at least one portion of the application data.

In various embodiments of the disclosure, the program instructions further cause the processor set to determine a first identifier associated with the computational environment based on the determination that the status data is indicative of the modified state of the at least one portion of the application data. The program instructions further cause the processor set to generate a first set of instructions based on the first identifier. The first set of instructions is generated to retrieve the modified at least one portion of the application data. The program instructions further cause the processor set to execute the generated first set of instructions. The program instructions further cause the processor set to retrieve the modified at least one portion of the application data from the computational environment based on the execution of the generated first set of instructions.

In various embodiments of the disclosure, the program instructions further cause the processor set to determine that the status data is indicative of an absence of cache data within the storage environment. The cache data is identical to the at least one portion of the application data. The program instructions further cause the processor set to retrieve the at least one portion of the application data from the computational environment based on the determination that the status data is indicative of the absence of the cache data within the storage environment. The program instructions further cause the processor set to transmit the retrieved at least one portion of the application data to the user device.

In various embodiments of the disclosure, the program instructions further cause the processor set to determine a second identifier associated with the computational environment based on the determination that the status data is indicative of the absence of the cache data within the storage environment. The program instructions further cause the processor set to generate a second set of instructions based on the second identifier. The second set of instructions is generated to retrieve the at least one portion of the application data. The program instructions further cause the processor set to execute the generated second set of instructions. The program instructions further cause the processor set to retrieve the at least one portion of the application data from the computational environment based on the execution of the generated second set of instructions.

In various embodiments of the disclosure, the program instructions further cause the processor set to generate the cache data identical to the at least one portion of the application data based on the retrieval of the at least one portion of the application data from the computational environment. The program instructions further cause the processor set to store the generated cache data within the storage environment.

In various embodiments of the disclosure, the program instructions further cause the processor set to update the status data based on the generation of the cache data. The updated status data is indicative of an unmodified state of the at least one portion of the application data within the computational environment. Further, the unmodified state of the at least one portion of the application data indicates that the at least one portion of the application data is unmodified within the computational environment based on the set of operations executed on the at least one portion of the application data. The program instructions further cause the processor set to output the updated status data.

In various embodiments of the disclosure, the program instructions further cause the processor set to determine that the status data is indicative of an unmodified state of the at least one portion of the application data within the computational environment. The program instructions further cause the processor set to retrieve cache data identical to the at least one portion of the application data from the storage environment based on the determination that the status data is indicative of the unmodified state of the at least one portion of the application data. The program instructions further cause the processor set to transmit the cache data to the user device.

In various embodiments of the disclosure, the program instructions further cause the processor set to determine an identifier associated with the storage environment based on the determination that the status data is indicative of the unmodified state of the at least one portion of the application data within the computational environment. The program instructions further cause the processor set to generate a third set of instructions based on the identifier associated with the storage environment. The program instructions further cause the processor set to execute the generated third set of instructions. The program instructions further cause the processor set to retrieve the cache data identical to the at least one portion of the application data from the storage environment based on the execution of the generated third set of instructions.

In various embodiments of the disclosure, the program instructions further cause the processor set to obtain the application data of the application, wherein the application data comprises at least application programming interface (API) data associated with a set of APIs of the application. The program instructions further cause the processor set to obtain the log data associated with the set of operations based on the API data. The program instructions further cause the processor set to determine map data indicative of at least an association between at least one API of the set of APIs and at least one operation of the set of operations based on the log data. The program instructions further cause the processor set to determine the status data based on the map data. The program instructions further cause the processor set to output the status data.

In various embodiments of the disclosure, a computer program product for retrieval of application data from data sources is provided. The program instructions are stored on the one or more computer-readable storage media to perform operations. The operations include receiving a request from a user device to obtain application data associated with an application. The user device, the application data, and a computer are associated with at least a computational environment. The operations include obtaining log data indicative of a set of operations executed on at least one portion of the application data. The operations include determining status data associated with the application data based on the log data. The operations include retrieving modified at least one portion of the application data based on a determination that the status data is indicative of a modified state of the at least one portion of the application data. The modified state of the at least one portion of the application data indicates that the at least one portion of the application data is modified within the computational environment. The at least one portion of the application data is modified based on the set of operations executed on the at least one portion of the application data. The operations include updating a storage environment with the modified at least one portion of the application data. The operations include transmitting the modified at least one portion of the application data to the user device.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or any freely propagating electromagnetic waves, electromagnetic waves propagating through a waveguide, light pulses passing through a fiber optic cable, electrical signals communicated through a wire, and/or any transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

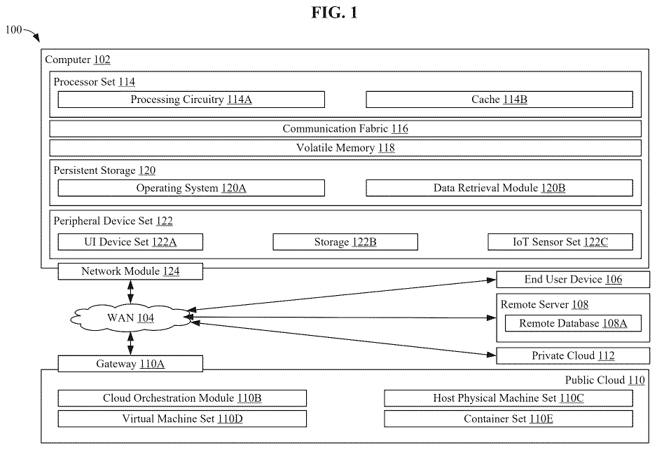

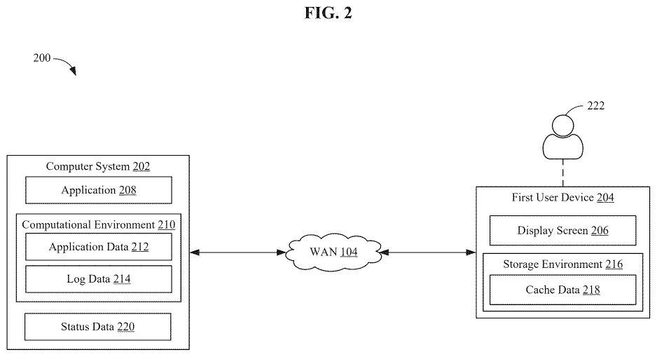

FIG. 1 is a diagram that illustrates a computing environment for retrieval of application data from data sources, in accordance with an embodiment of the disclosure. With reference to FIG. 1, there is shown a computing environment 100 that contains an example of an environment for execution of at least some of the computer code/module involved in performing the methods, such as a data retrieval module 120B. In addition to the data retrieval module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the data retrieval module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any form of a computer or a mobile device now known or to be developed in the future that is configured to run a program, access a network or query a database, such as a remote database 108A. As is well understood in the art of computer technology, and depending upon the technology, the performance of a computer-implemented method may be distributed among multiple computers and/or between multiple locations. Alternatively, in this presentation of the computing environment 100, detailed discussion is focused on a single computer, specifically the computer 102, to keep the presentation as simple as possible. The computer 102 may be located in a cloud, even though it is not shown in a cloud in FIG. 1. Alternatively, computer 102 does not need to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and various storage media discussed below. The program instructions, and associated data, are accessed by the processor set 114 to control and direct the performance of the methods. In computing environment 100, at least some of the instructions for performing the methods may be stored in the dynamic modification of the data retrieval module 120B in persistent storage 120.

The communication fabric 116 is the signal conduction path that allows the various components of computer 102 to communicate among themselves. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not needed unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the data retrieval module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is needed to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In an embodiment of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) configured to communicate computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is illustrated as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that allows orchestration, management, and/or data/application portability between the multiple constituent clouds. In this embodiment of the disclosure, the public cloud 110 and the private cloud 112 are both part of a larger hybrid cloud.

FIG. 2 is a diagram that illustrates an environment for retrieval of application data from data sources, in accordance with an embodiment of the disclosure. FIG. 2 is explained in conjunction with elements from FIG. 1. With reference to FIG. 2 there is shown a network environment 200. The network environment 200 includes a computer system 202, a first user device 204 that includes a display screen 206. The computer system 202 is configured to host an application 208. Further, the computer system 202 is associated with a computational environment 210. The computational environment 210 is configured to store application data 212 associated with the application 208. Further, the computational environment 210 is configured to store log data 214 indicative of a set of operations executed on at least one portion of the application data 212. The first user device 204 is associated with a storage environment 216. The storage environment 216 is configured to store cache data 218 identical to the at least one portion of the application data 212. The computer system 202 is configured to determine status data 220 associated with the application data 212. With reference to FIG. 2, there is further shown a user 222 associated with the first user device 204 and the WAN 104 of FIG. 1. In an embodiment of the disclosure, the computer system 202 is an exemplary embodiment of the computer 102 in FIG. 1. Similarly, in an embodiment of the disclosure, the first user device 204 is an example embodiment of the EUD 106 of FIG. 1.

The computer system 202 includes suitable logic, circuitry, interfaces, and/or code that are configured to receive a request from the first user device 204 to obtain application data 212 associated with the application 208. The first user device 204, the application data 212, and the computer system 202 are associated with at least the computational environment 210. The computer system 202 is configured to obtain the log data 214 indicative of the set of operations executed on the at least one portion of the application data 212. The computer system 202 is configured to determine the status data 220 associated with the application data 212 based on the log data 214. The computer system 202 is configured to retrieve modified at least one portion of the application data 212 based on a determination that the status data 220 is indicative of the modified state of the at least one portion of the application data 212. The modified state of the at least one portion of the application data 212 indicates that the at least one portion of the application data 212 is modified within the computational environment 210. The at least one portion of the application data 212 is modified based on the set of operations executed on the at least one portion of the application data 212. The computer system 202 is configured to update the storage environment 216 with the modified at least one portion of the application data 212. The computer system 202 is configured to transmit the modified at least one portion of the application data 212 to the first user device 204.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. In an example embodiment of the disclosure, the computer system 202 may be embodied as a cloud-based service, a cloud-based application, a cloud-based platform, a remote server-based service, a remote server-based application, a remote server-based platform, or a virtual computing system.

The first user device 204 may include suitable logic, circuitry, interfaces, and/or code that are configured to transmit the request to obtain the application data 212 associated with the application 208, the application data 212, or a combination thereof. The first user device 204 is further configured to transmit the request to obtain the application data 212 associated with the application 208, the application data 212, or a combination thereof to the computer system 202. In an embodiment, the first user device 204 may include the display screen 206. In an embodiment of the disclosure, the first user device 204 is further configured to display the request to obtain the application data 212 associated with the application 208, the application data 212, or a combination thereof on the display screen 206 associated with the first user device 204. The first user device 204 may be associated with the user 222. In an embodiment of the disclosure, the user 222 may be a person who wishes to retrieve the at least one portion of the application data 212 from the computational environment 210. In an embodiment of the disclosure, the user 222 may correspond to a stand-alone user (such as an end user of the application data 212). Examples of the first user device 204 may include, but are not limited to, a computing device, a mainframe machine, a server, a computer work-station, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any device with computer vision display capabilities.

The display screen 206 may include suitable logic, circuitry, and interfaces that are configured to render the request to obtain the application data 212 associated with the application 208, the application data 212, the at least one portion of the application data 212, the cache data 218, or a combination thereof. In some embodiments of the disclosure, the display screen 206 may be an external display device associated with the first user device 204. The display screen 206 may be a touch screen which may allow the user 222 to provide the request to obtain the application data 212 associated with the application 208. The touch screen may be at least one of a resistive touch screen, a capacitive touch screen, or a thermal touch screen. In accordance with an embodiment of the disclosure, the display screen 206 may refer to a display screen 206 of a head-mounted device (HMD), a smart-glass device, a see-through display, a projection-based display, an electro-chromic display, or a transparent display. In some embodiments of the disclosure, the display screen 206 may be realized through several known technologies such as, but are not limited to, at least one of a Liquid Crystal Display (LCD) display, a Light Emitting Diode (LED) display, a plasma display, or an Organic LED (OLED) display technology, or any display devices.

The application 208 includes a set of instructions, routines, or algorithms that are associated with one or more processes of the application 208. The set of instructions, the routines, or the algorithms may be stored in a non-transitory computer-readable medium associated with the computer system 202. In an embodiment of the disclosure, the computer system 202 is configured to execute the one or more processes of the application 208 within the computational environment 210. In various embodiments of the disclosure, the computer system 202 is configured to execute the one or more processes of the application 208 on the first user device 204. The one or more processes include, but are not limited to, data retrieval processes, data validation processes, data storage processes, data rendering processes, and data transmitting processes. Examples of the application 208 include, but are not limited to, web-based applications, mobile applications, cloud-based applications, standalone software programs, and embedded software programs.

The computational environment 210 includes suitable logic, circuitry, and interfaces that are configured to store the application data 212 associated with the application 208. The computational environment 210 is configured to store the application data 212 based on the execution of the set of operations on the application data 212. In an embodiment of the disclosure, the computer system 202 is configured to execute the set of operations on the application data 212. In various embodiments of the disclosure, the computational environment 210 is configured to execute the set of operations on the application data 212. In various embodiments of the disclosure, the first user device 204 is configured to execute the set of operations on the application data 212. In various embodiments of the disclosure, the application 208 is configured to execute the set of operations on the application data 212. Examples of the computational environment 210 include, but are not limited to, a tenant management environment, a customer relationship environment, a payment processing platform, a document management environment, an inventory management environment, and a communication environment. Further, examples of the set of operations include, but are not limited to, provisioning of the application data 212, a management of the application data 212, and a user interaction associated with the user 222 of the application 208. The computational environment 210 is further configured to store the log data 214 indicative of the set of operations executed on the at least one portion of the application data 212. The log data 214 includes a timestamp associated with each operation of the set of operations, a type associated with each operation of the set of operations, an identifier associated with each operation of the set of operations, a result associated with each operation of the set of operations, or a combination thereof.

The storage environment 216 corresponds to a memory that is located in a set of processor chip packages (such as integrated circuit chips) associated with the first user device 204. The storage environment 216 is configured to store the cache data 218 identical to the at least one portion of the application data 212. In an embodiment, the storage environment 216 is configured to store the cache data 218 for a time period (such as 30 seconds, 5 minutes, 10 hours, 1 day, or 1 month). In an embodiment, the storage environment 216 is configured to store the at least one portion of the application data 212 until a reception of user input. The user input corresponds to a deletion of the cache data 218 within the storage environment 216.

For example, the application data 212 corresponds to data that is associated and/or utilized during the execution of the application 208 by the computer system 202. For example, the application data 212 may include text, audio, a video, a hypertext markup language (HTML) page, a database, and the like. For example, the cache data 218 corresponds to data that is stored in the storage environment 216 of the first user device 204. A person having ordinary skills in the art would appreciate that the storage environment 216 corresponds to storage that allows direct access to a processor of the first user device 204 and is disposed on the same die as that of the processor itself. Accordingly, the access to the cache data 218 is faster in comparison to the access to the data stored elsewhere. For example, the cache data 218 may include the application data 212.

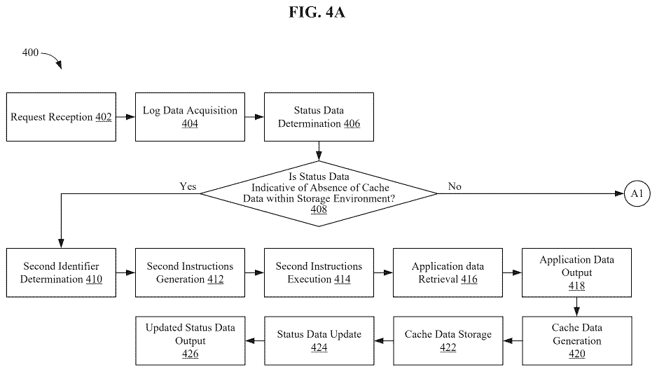

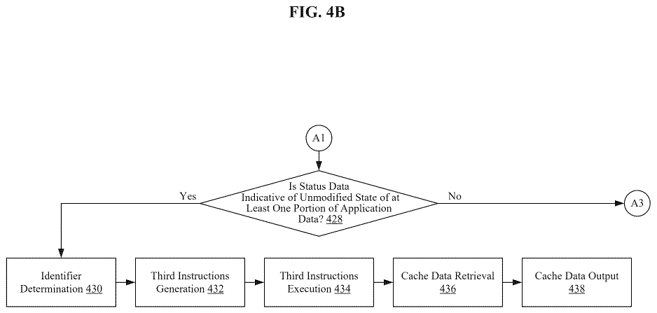

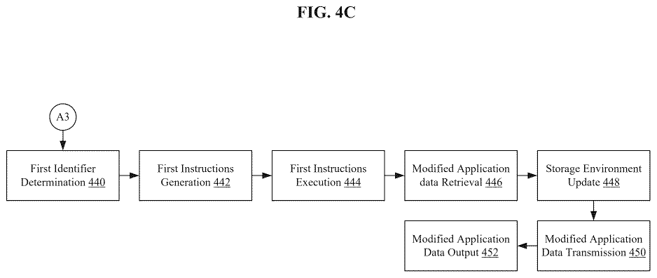

In operation, the computer system 202 is configured to receive the request from the first user device 204 to obtain the application data 212 associated with the application 208. The first user device 204, the application 208, and the computer system 202 are associated with at least the computational environment 210. For example, the application data 212 is being stored on the computer system 202. In an additional example, the application data 212 is stored on an external computing device or a database without departing from the scope of the disclosure. The application data 212 is associated with one or more processes of the application 208. In an embodiment of the disclosure, the computer system 202 is configured to receive the request to obtain the at least one portion of the application data 212. Details about the reception of the request data are provided, for example, FIG. 4A, FIG. 4B, and FIG. 4C.

The computer system is further configured to obtain the log data 214 indicative of the set of operations (such as a data update operation, a data read operation, a data delete operation, and the like) executed on the at least one portion of the application data 212. For example, a timestamp (denoted as eventTime) associated with the data update operation is 2014-01 17T23:23:38.109989+0000, the identifier (denoted as action) of the operation is update, a type (denoted as type) associated with the operation is activity, an identifier (denoted as id) of an entity associated with the operation is a tenant:a80dc5ee-be83-48ad-ad5e6577f2217637, a result (denoted as outcome) associated with the operation is a success, and a type (denoted as type) of the entity associated with the operation is tenant/tenant. The log data 214 can be defined as:

{
“type”: “activity”,
“action”: “update”,
“outcome”: “success”,
“eventTime”: “2014-01-
17T23:23:38.109989+0000”,
“target”: {
“id”: “tenant: a80dc5ee-be83-48ad-ad5e6577f2217637”,
“type”: “tenant/tenant”
}

The computer system 202 is configured to determine the status data 220 associated with the application data 212 based on the log data 214. In an embodiment of the disclosure, the status data 220 corresponds to a modified state value (such as 1, modified, and the like) that is indicative of a modified state of the at least one portion of the application data 212. The modified state of the at least one portion of the application data 212 indicates that the at least one portion of the application data 212 is modified within the computational environment 210. In various embodiments of the disclosure, the status data 220 corresponds to the unmodified state value (such as 0, unmodified) that is indicative of the unmodified state of the at least one portion of the application data 212.

The utilization of the log data 214 allows the computer system 202 to determine the status data 220 without transmitting the one or more data requests to the computational environment 210. Specifically, the computer system 202 is configured to determine an association of the executed set of operations with the at least one portion of the application data 212 based on the log data 214. Further, the computer system 202 is configured to determine the status data 220 based on the determined association between the executed set of operations and the at least one portion of the application data 212. For example, the computer system 202 is configured to determine that the data update operation updates the at least one portion of the application data 212. The computer system 202 is configured to compare an identifier (update) of the data update operation with a set of action identifiers. Each operation of the corresponding action identifier of the set of action identifiers is configured to update the at least one portion of the application data 212. Further, the computer system 202 is configured to determine the status data 220 corresponding to the modified state value based on the determination that the update operation indicates the at least one portion of the application data 212.

Further, the computer system 202 is configured to retrieve modified at least one portion of the application data 212 based on the determination that the status data 220 in indicative of the modified state of the at least one portion of the application data 212. Additionally, the computer system 202 is configured to update the storage environment 216 with the modified at least one portion of the application data 212. The determination of the status data 220 allows the computer system 202 to determine the correct time period for the updating of the storage environment 216, thereby reducing the likelihood of the transmission of outdated application data to the user 222 at a time period. The outdated application data is different from the application data 212 that is stored within the computational environment 210 at the time period. Moreover, the computer system 202 is configured to transmit the modified at least one portion of the application data 212 to the first user device 204.

In an alternative embodiment of the disclosure, the computer system 202 is configured to retrieve the cache data 218 from the storage environment 216 based on a determination that status data 220 is indicative of the unmodified state of the at least one portion of the application data 212. In an embodiment of the disclosure, the computer system 202 is configured to determine that the status data 220 corresponds to the unmodified state value based on the association between the executed set of operations and the at least one portion of the application data 212.

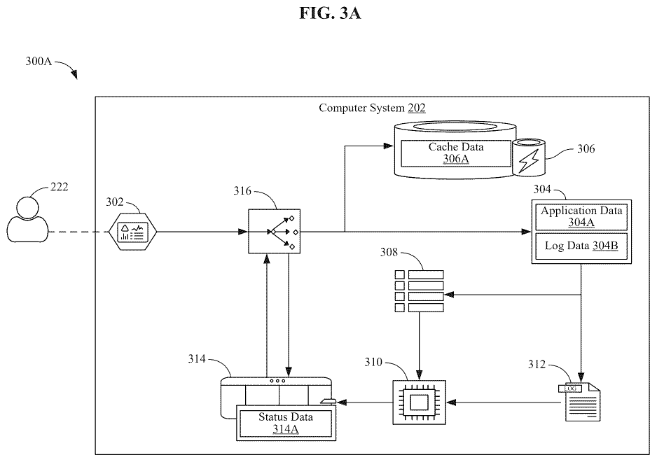

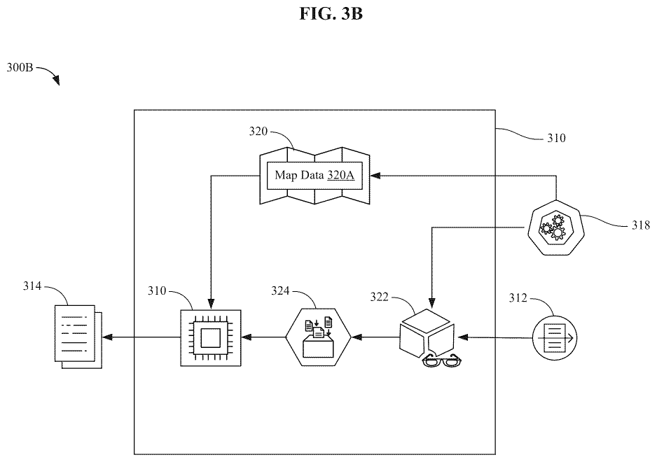

In an additional example, the computer system 202 is configured to determine that the at least one portion of the application data 212 is unmodified based on the execution of an action (the data read operation). The computer system 202 is configured to compare an identifier of the data read operation with the set of action identifiers. Further, the computer system 202 is configured to determine the status data 220 corresponding to the unmodified state value based on the determination that the identifier associated with the data read operation is absent within the set of action identifiers. The operations for retrieving the at least one portion of the application data 212 from data sources (such as the computational environment 210 or the storage environment based on the status data 220 are herein further described in conjunction with FIG. 3A and FIG. 3B.

FIG. 3A is a diagram that illustrates first exemplary operations for retrieval of application data from data sources, in accordance with an embodiment of the disclosure. FIG. 3A is explained in conjunction with elements from FIG. 1 and FIG. 2. With reference to FIG. 3A, there is shown a block diagram 300A that illustrates the first exemplary operations, as described herein. With reference to FIG. 3A, there is shown the computer system 202 of FIG. 1 that includes an application 302, a computational environment 304, a storage environment 306, a register module 308, an analyzer module 310, a logging module 312, a change status module 314, and a dispatcher module 316. In an embodiment of the disclosure, the application 302, the computational environment 304, and the storage environment 306 are exemplary embodiments of the application 208, the computational environment 210, and the storage environment 216 of FIG. 2, respectively. Further, the computational environment 304 is configured to store application data 304A associated with the application 302. The computational environment 304 is further configured to store log data 304B indicative of a set of operations executed on the at least one portion of the application data 304A. The storage environment 306 is configured to store cache data 306A identical to the at least one portion of the application data 304A.

The register module 308 of the computer system 202 is configured to obtain the application data 304A of the application 302. The application data 304A is associated with at least the computational environment 304. In an embodiment of the disclosure, the computer system 202 is configured to obtain the application data 304A from a user device (such as the first user device 204). For example, the computer system 202 is configured to obtain the application data 304A from the cache data 306A of the storage environment 306. In an embodiment of the disclosure, the register module 308 is configured to transmit the application data 304A to the analyzer module 310 of the computer system 202. Details about the application data 304A are provided, for example, in FIG. 4A, FIG. 4B, and FIG. 4C. The logging module 312 of the computer system 202 is configured to obtain the log data 304B from the computational environment 304. In an embodiment of the disclosure, the logging module 312 is configured to transmit the log data 304B to the analyzer module 310 of the computer system 202. Details about the log data 304B are provided, for example, in FIG. 4A, FIG. 4B, and FIG. 4C. The analyzer module 310 of the computer system 202 is configured to determine status data 314A based on the log data 304B. Details about the determination of the status data 314A are provided, for example, in FIG. 4. In an embodiment of the disclosure, the analyzer module 310 is configured to transmit the determined status data 314A to the change status module 314. The analyzer module 310 is further explained in detail with reference to FIG. 3B.

The change status module 314 is configured to store the status data 314A. Details about the status data 314A are provided, for example, in FIG. 4A, FIG. 4B, and FIG. 4C. The dispatcher module 316 is configured to receive a request from the user device to obtain the application data 304A associated with the application 302. The user device, the application data 304A, and the computer system 202 are associated with at least the computational environment 304. The dispatcher module 316 is further configured to transmit the request to the change status module 314. Further, the dispatcher module 316 is configured to obtain the status data 314A from the change status module 314.

In an embodiment of the disclosure, the dispatcher module 316 is further configured to retrieve the at least one portion of the application data 304A from the computational environment 304 based on a determination that the status data is indicative of an absence of the cache data 306A within the storage environment 306. In an embodiment of the disclosure, the dispatcher module 316 is further configured to retrieve cache data 306A identical to the at least one portion of the application data 304A within the computational environment 304 based on a determination that the status data 314A is indicative of an unmodified state of the at least one portion of the application data 304A. In an embodiment of the disclosure, the dispatcher module 316 is further configured to retrieve modified at least one portion of the application data 304A from the computational environment 304 based on a determination that the status data 314A is indicative of a modified state of the at least one portion of the application data. The modified state of the at least one portion of the application data 304A indicates that the at least one portion of the application data 304A is modified within the computational environment 304.

FIG. 3B is a diagram that illustrates second exemplary operations for retrieval of application data from data sources, in accordance with an embodiment of the disclosure. FIG. 3B is explained in conjunction with elements from FIG. 1, FIG. 2, and FIG. 3A. With reference to FIG. 3B, there is shown a block diagram 300B that illustrates the second exemplary operations, as described herein. With reference to FIG. 3B, there is shown the computer system 202 of FIG. 1 which includes an API registry module 318, an API resource impact mapper module 320, a log watcher module 322, and a log formatter module 324. With reference to FIG. 3B, there is further shown the analyzer module 310, the logging module 312, the change status module 314 of FIG. 3B.

The log watcher module 322 includes suitable logic and/or circuitry that allows the computer system 202 to monitor changes to the log data. To this end, the log watcher module 322 is configured to query the API registry module to retrieve the API identifiers. Thereafter, the log watcher module 322 is configured to retrieve the timestamp associated with the entries in the log data to determine if the application data may have been modified. The log watcher module 322 may be implemented through an FPGA or a SOC without departing from the scope of the disclosure.

In operation, The API registry module 318 is configured to transmit the application data 304A to the API resource impact mapper module 320, the log watcher module 322, or a combination thereof. In an embodiment of the disclosure, the API registry module 318 includes suitable logic, circuitry, and interfaces that allow the computer system 202 to store a set of APIs that is configured to modify the application data 212. Each API of the set of APIs corresponds to a set of functions that is executed by the user 222 (such as an application developer of the application 208) to modify the application 208 and/or the application data 212. Additionally, each API of the set of APIs is configured to provide access to the application data 212 based on one or more unique keys. In an embodiment, the API registry module 318 corresponds to a lookup table that includes a list of API functions and the corresponding API identifiers. The computer system 202 is configured to access the API registry module 318 based on the one or more data queries (such as a structured query language (SQL) data query, a NoSQL data query, a MongoDB data query, a graph query language data query, a hypertext transfer protocol, and the like). Examples of the API registry module 318 include, but are not limited to, a MySQL module, a MongoDB module, and an API gateway.

The log watcher module 322 is configured to obtain the application data 304A from the API registry module 318. The application data includes 304A includes at least application programming interface (API) data associated with a set of APIs of the application 302. Each API of the set of APIs corresponds to a set of protocols that allows communication of various applications. Further, each API of the set of APIs allows a first program of a first application to access functions and data of a second program of a second program. The API data includes at least an identifier associated with each API of the set of APIs. For example, a first identifier of a first API of the set of APIs is indicative of a first file path associated with at least one entity of the set of entities (such as the application 302, the computational environment 304, the storage environment 306, the user device of the user 222). The at least one entity of the set of entities is associated with the set of operations. Details about the application data 304A are provided, for example, in FIG. 4A, FIG. 4B, and FIG. 4C.

The log watcher module 322 is further configured to obtain the log data 304B from the logging module 312. The log watcher module 322 includes suitable logic, circuitry, and interfaces that allow the computer system 202 to detect one or more changes associated with the log data 304B. Further, the log watcher module 322 is configured to obtain the log data 304B based on the detection of the one or more changes associated with the log data 304B. The log watcher module 322 may be implemented through an FPGA or a SOC without departing from the scope of the disclosure.

The log data 304B includes a timestamp associated with the operation of the set of operations, the identifier of the operation, a type associated with the operation, an identifier of an entity associated with the operation, and a result associated with the operation is a success and a type of the entity associated with the operation. Details about the log data 304B are provided, for example, in FIG. 4A, FIG. 4B, and FIG. 4C. The log watcher module 322 is further configured to transmit the application data 304A, the log data 304B, or a combination thereof to the log formatter module 324.

The log formatter module 324 is configured to extract at least one portion of the log data 304B. The log formatter module 324 is further configured to transmit the extracted at least one portion of the log data 304B and the application data 304A. The log formatter module 324 includes suitable logic, circuitry, and interfaces that allow the computer system 202 to parse the log data 304B to retrieve a set of records corresponding to the set of operations executed on at least one portion of the application data 212. The set of records is indicative of one or more modifications associated with the at least one portion of the application data 212. For example, the log formatter module 324 is configured to retrieve the set of records (such as an extensible markup language (XML), a Javascript object notation (JSON), comma-separated values (CSV), and an HTML) based on one or more log formatting protocols. The log watcher module 322 may be implemented through a field-programmable gate array (FPGA) or a security operation center (SOC) without departing from the scope of the disclosure. Details about the extracted at least one portion of the log data 304B are provided, for example, in FIG. 4A, FIG. 4B, and FIG. 4C.

The API resource impact mapper module 320 is configured to determine map data 320A indicative of an association between at least one API of the set of APIs and at least one operation of the set of operations based on the log data 304B. In an embodiment of the disclosure, the computer system 202 is configured to determine the map data 320A based on the extracted at least one portion of the log data 304B. For example, the API resource impact mapper module 320 includes suitable logic and/or circuitry that allows the computer system 202 to map the set of API identifiers to the set of operations that is executed on the application data 212. Further, the API resource impact mapper module 320 is configured to determine the map data based on the mapping between the set of API identifiers and the set of operations. Details about the map data 320A are provided, for example, in FIG. 4A and FIG. 4B. For example, the API resource impact mapper module 320 may be implemented through the FPGA or the SOC without departing from the scope of the disclosure. The API resource impact mapper module 320 is further configured to transmit the map data 320A to the analyzer module 310.

The analyzer module 310 is configured to determine the status data 314A based on the map data. The analyzer module 310 includes suitable logic and/or circuitry that allows the computer system 202 to determine whether the application data 212 has been modified. For example, the computer system 202 utilizes the analyzer module 310 to retrieve the parsed log data from the log formatter module 324. Thereafter, the analyzer module 310 is configured to retrieve the map data from the API resource impact mapper module 320. As discussed, the map data is indicative of at least one association between the at least one API of the set of APIs and at least one operation of the set of operations. Specifically, the map data includes a mapping between the set of API identifiers and the operations executed by the corresponding API functions. To this end, the analyzer module 310 is configured to determine the identifiers from the parsed log and utilize the API identifiers to determine the operations performed on the applications. Based on the operations executed on the application data 212, the analyzer module 310 is configured to determine that the application data 212 is modified. Accordingly, the analyzer module 310 is further configured to update the status data 314A. The analyzer module 310 is configured to transmit the status data 314A to the change status module 314. The change status module 314 is configured to store the status data 314A based on the reception of the status data 314A from the analyzer module 310.

FIG. 4A, FIG. 4B and FIG. 4C collectively is a diagram that illustrates exemplary operations for retrieval of application data from data sources, in accordance with an embodiment of the disclosure. FIG. 4A, FIG. 4B and FIG. 4C are explained in conjunction with elements from FIG. 1, FIG. 2, FIG. 3A and FIG. 3B. With reference to FIG. 4A, FIG. 4B and FIG. 4C, there is shown a block diagram 400 that illustrates exemplary operations from 402 to 450, as described herein. The exemplary operations illustrated in the block diagram 400 may start at 402 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a request reception operation is executed. In the request reception operation, the computer system 202 is configured to receive the request from the first user device 204 to obtain the application data 212 associated with the application 208. The first user device 204, the application data 212, and the computer system 202 are associated with the at least the computational environment 210.

In an embodiment of the disclosure, the computer system 202 is configured to receive the request to obtain the at least one portion of the application data 212. In an embodiment of the disclosure, the computer system 202 is configured to receive the request from the first user device 204. In various embodiments of the disclosure, the computer system 202 is configured to receive the request based on the execution of the application 208 on the first user device 204. Specifically, the computer system 202 is configured to receive the request from one or more instance objects (such as methods, classes, interfaces, and the like) associated with the execution of the application 208. In an embodiment of the disclosure, the request includes an identifier associated with the user 222, an identifier associated with the at least one portion of the application data 212, or a combination thereof. For example, the identifier associated with the user 222 corresponds to a name of the user 222. In an additional example, the identifier associated with the user 222 corresponds to a set of unique characters (such as 1, A, Z, z, a, #, and the like). In an additional example, the identifier associated with the at least one portion of the application data 212 corresponds to a set of unique content characters (such as 1, A, Z, z, a, #, and the like).

At 404, a log data acquisition operation is executed. In the log data acquisition operation, the computer system 202 is configured to obtain the log data 214 indicative of the set of operations executed on the at least one portion of the application data 212. In various embodiments of the disclosure, the logging module 312 is configured to obtain the log data 214 indicative of the set of operations executed on the at least one portion of the application data 212. In an embodiment of the disclosure, the computer system 202 is configured to obtain the log data 214 from the computational environment 210. In various embodiments of the disclosure, the computer system 202 is configured to obtain the log data 214 based on the execution of the application 208. In various embodiments of the disclosure, the computer system 202 is configured to obtain the log data 214 based on the execution of each process of the one or more processes associated with the application 208. In an embodiment of the disclosure, the computer system 202 is configured to obtain the log data 214 from the computational environment 210. In various embodiments of the disclosure, the computer system 202 is configured to obtain the log data 214 from the first user device 204. In an embodiment of the disclosure, the computer system 202 is configured to obtain the log data 214 from a user input associated with the log data 214.

In various embodiments of the disclosure, the computer system 202 is configured to obtain the log data 214 based on a set of standards. The set of standards is associated with the storage of the log data 214 within the computational environment 210. The utilization of the set of standards allows for the acquisition of the log data 214 in a predefined format. For example, the set of standards corresponds to Cloud Auditing Data Federation (CADF) standards. The CADF standards include, but are not limited to, a set of model components indicative of the set of operations executed on the at least one portion of the application data 212, a set of fields associated with the set of model components, a set of CADF definitions associated with the set of operations, and a set of entities associated with the set of operations. Accordingly, the CADF standards are provided with reference to Table 1:

TABLE 1
CADF STANDARDS

| Model Component | | Field | CADF definition |
|---|---|---|---|
| 1. | OBSERVER | observer.id | A first entity (such as the logging |
| | | observer. type | module 312) of the set of entities |
| | | | that generates the log data 214 based |
| | | | operations on the at least one portion |
| | | | of the application data 212. |
| 2. | INITIATOR | initiator.id | A second entity (such as the first |
| | | initiator.type | user device 204) of the set of entities |
| | | | that initiated or executed the set of |
| | | | operations on the at least one portion |
| | | | of the application data 212. |
| 3. | ACTION | event.action | A first operation (such as a read |
| | | event.type | operation) of the set of operations |
| | | event.eventTime | that the second entity has executed, |
| | | | attempted to execute, or has pending |
| | | | against a fourth entity (such as the |
| | | | computational environment 210) of |
| | | | the set of entities. |
| 4. | TARGET | target.id | The fourth entity against which the |
| | | target.type | first operation was performed, was |
| | | | attempted, or is pending. |
| 5. | OUTCOME | event.outcome | The result (such as a success or a |
| | | | failure) associated with the first |
| | | | operation against the fourth entity. |

In an embodiment of the disclosure, the log data 214 includes the timestamp associated with each operation of the set of operations, the type associated with each operation of the set of operations, the identifier associated with each operation of the set of operations, the result associated with each operation of the set of operations, or any combination thereof. Additionally, the log data 214 includes an identifier of each entity of a set of entities associated with the set of operations, a type associated with the entity of the set of entities, and a combination thereof.

For example, a timestamp (denoted as eventTime) associated a second operation (denoted as action) of the set of operations is 2014-01 17T23:23:38.109989+0000, the second operation corresponds to a data update operation (denoted as update), a type (denoted as type) associated with the second operation is activity, the identifier (denoted as id) associated with an entity associated with the second operation is tenant:a80dc5ee-be83-48ad-ad5e6577f2217637, a result (denoted as outcome) associated with the second operation is success, and a type (denoted as type) of the entity associated with the second operation is tenant/tenant. Accordingly, the log data 214 is provided with reference to Schema 1:

{
“type”: “activity”,
“action”: “update”,
“outcome”: “success”,
“eventTime”: “2014-01-
17T23:23:38.109989+0000”,
“target”: {
“id”: “tenant: a80dc5ee-be83-48ad-ad5e6577f2217637”,
“type”: “tenant/tenant”
}

In an additional example, a timestamp (denoted as eventTime) associated with a third operation (denoted as action) is “2014-01-17T23:23:38.109989+0000”, the third operation corresponds to a data deletion operation (denoted as delete), a type (denoted as type) associated with the third operation is activity, an identifier (denoted as id) of the entity associated with the third operation is tenant:a80dc5ee-be83-48ad-ad5e6577f2217638, a result (denoted as outcome) associated with the third operation is success, and a type (denoted as type) of the entity associated with the third operation is data/database. Accordingly, the log data 214 is provided with reference to Schema 2 as:

{
{
“type”: “activity”,
“action”: “delete”,
“outcome”: “success”,
“eventTime”: “2014-01-
17T23:23:38.109989+0000”,
“target”: {
“id”: “tenant: a80dc5ee-be83-48ad-ad5e6577f2217638”,
“type”: “data/database”
}
}

In yet additional example, the log data 214 is indicative of the set of operations executed on the at least one portion of the application data 212. The at least one portion of the application data 212 is associated with the set of entities (such as a tenant associated with the first user device 204, a database associated with the computer system 202). Accordingly, the log data 214 is provided with reference to Table 2:

TABLE 2
LOG DATA

| action | | target.type | target.id |
|---|---|---|---|
| 1. | create | tenant/tenant | tenant:a80dc5eebe83-48ad- |
| | | | ad5e6577f221 |
| 2. | update | tenant/tenant | tenant:a80dc5eebe83-48ad- |
| | | | ad5e6577f22176 |
| 3. | delete | tenant/tenant | tenant:a80dc5eebe83-48ad- |
| | | | ad5e6577f221763 |
| 4. | create | data/database | tenant:a80dc5eebe83-48ad- |
| | | | ad5e6577f2217638 |
| 5. | update | data/database | tenant:a80dc5eebe83-48ad- |
| | | | ad5e6577f2217638 |
| 6 | delete | data/database | tenant:a80dc5eebe83-48ad- |
| | | | ad5e6577f2217638 |

At 406, a status data determination operation is executed. In the status data determination operation, the computer system 202 is configured to utilize the analyzer module 310 to determine the status data 220. In various embodiments of the disclosure, the analyzer module 310 is configured to determine the status data 220 based on the log data 214. In an embodiment of the disclosure, the computer system 202 is configured to determine the status data 220 based on the execution of the application 208. In various embodiments of the disclosure, the computer system 202 is configured to determine the status data 220 based on the execution of each process of the one or more processes of the application 208. In various embodiments of the disclosure, the computer system 202 is configured to iteratively determine the status data 220 based on a first time period (such as 1 second, 5 seconds, 1 hour, 1 day, and the like).

In an embodiment of the disclosure, the computer system 202 is configured to determine the status data 220 based on the log data 214 and the application data 212. Specifically, the computer system 202 is configured to obtain the application data 212 of the application 208. The application data 212 includes at least application programming interface (API) data associated with a set of APIs of the application 208. Each API of the set of APIs corresponds to a set of protocols that allows communication of various applications. Further, each API of the set of APIs allows a first program of a first application to access functions and data of a second program. The API data includes at least an identifier associated with each API of the set of APIs. The computer system 202 is further configured to determine map data based on the log data 214 and the API data. The map data is indicative of at least an association between at least one API of the set of APIs and at least one operation of the set of operations.

The map data includes the set of operations (denoted by action) associated with the set of APIs, a type (denoted by type) of the set of entities associated with the set of APIs, an identifier of the set of entities (denoted by resource) associated with the set of APIs, and the identifier (denoted by API) associated with each API of the set of APIs. In an embodiment of the disclosure, the computer system 202 is configured to extract at least one portion of the log data 214 from the log data 214. The at least one portion of the log data 214 includes the set of operations (denoted by action) associated with the set of APIs, the type (denoted by type) of the set of entities associated with the set of APIs, the identifier of each entity of the set of entities (denoted by resource) associated with the set of APIs. Further, the computer system 202 is configured to merge the extracted at least one portion of the log data 214 and the API data to determine the map data. Accordingly, the map data is provided with reference to Table 3:

TABLE 3
MAP DATA

| Action | | Type | Resource | API |
|---|---|---|---|---|
| 1. | create | tenant/tenant | <id1> | GET/tenant/<id1> |
| 2. | update | tenant/tenant | <id2> | GET/tenants<id2> |
| 3. | clean | database/database | <id3> | GET/tenants<id3> |
| 4. | create | Database/database | <id4> | GET/tenant/<id4> |

Referring back to Table 3, the map data includes a first operation (create) associated with a first type (tenant/tenant) of a first entity. The first entity is associated with a first identifier (<id1>). Additionally, the first operation is associated with a first identifier (denoted by GET/tenant/<id1>) of the CREATE API. In an embodiment of the disclosure, the first identifier (<id1>) corresponds to a first file path associated with a device (such as the first user device 204) of the first entity (such as the user 222). Further, the computer system 202 is configured to determine a first association between the CREATE API and the first operation (create). The first association indicates that the at least one portion of the application data 212 is unmodified based on the execution of the first operation. In an embodiment of the disclosure, the computer system 202 is configured to determine the occurrence of the first identifier of the CREATE API within a set of API identifiers. The corresponding API of each identifier of the set of API identifiers is configured to modify the at least one portion of the application data 212. Further, the computer system 202 is configured to determine that the at least one portion of the application data 212 is unmodified based on a determination that the first identifier of the CREARE API is absent within the set of API identifiers.

The map data further includes a second operation (update) associated with a second type (tenant/tenant) of a second entity. The second entity is associated with a second identifier (<id2>). Additionally, the second operation is associated with a second identifier (denoted by GET/tenant/<id2>) of the UPDATE API. In an embodiment of the disclosure, the second identifier (<id2>) corresponds to a second file path associated with a device of the second entity.

Further, the computer system 202 is configured to determine a second association between the UPDATE API and the second operation (update). The second association indicates that the at least one portion of the application data 212 is modified based on the execution of the second operation. In an embodiment of the disclosure, the computer system 202 is configured to determine an occurrence of the second identifier of the UPDATE API within the set of API identifiers. Further, the computer system 202 is configured to determine that the at least one portion of the application data 212 is modified based on a determination that the second identifier of the UPDATE API is present within the set of API identifiers.

The map data further includes a third operation (clean) associated with a third type (database/database) of a third entity. The third entity is associated with a third identifier (<id3>). Additionally, the third operation is associated with a third identifier (denoted by GET/tenant/<id3>) of the CLEAN API. In an embodiment of the disclosure, the third identifier (<id3>) corresponds to a third file path associated with a module (such as the computational environment 210) of the third entity (the computer system 202).

Further, the computer system 202 is configured to determine a third association between the CLEAN API and the third operation (clean). The third association indicates that the at least one portion of the application data 212 is modified based on the execution of the third operation. In an embodiment of the disclosure, the computer system 202 is configured to determine an occurrence of the third identifier of the CLEAN API within the set of API identifiers. Further, the computer system 202 is configured to determine that the at least one portion of the application data 212 is modified based on a determination that the third identifier of the CLEAN API is present within the set of API identifiers.

The map data further includes a fourth operation (create) associated with a fourth type (database/database) of a fourth entity. The fourth entity is associated with a fourth identifier (<id4>). Additionally, the fourth operation is associated with a fourth identifier (denoted by GET/tenant/<id4>) of the CREATE API. In an embodiment of the disclosure, the fourth identifier (<id4>) corresponds to a fourth file path associated with the module (such as the computational environment 210) of the fourth entity (the computer system 202).

Further, the computer system 202 is configured to determine a fourth association between the CREATE API and the third operation (create). The fourth association indicates that the at least one portion of the application data 212 is modified based on the execution of the fourth operation. In an embodiment of the disclosure, the computer system 202 is configured to determine an occurrence of the fourth identifier of the CREATE API within the set of API identifiers. Further, the computer system 202 is configured to determine that the at least one portion of the application data 212 is modified based on a determination that the fourth identifier of the CREATE API is present within the set of API identifiers.

In an embodiment of the disclosure, the computer system 202 is configured to determine the status data 220 based on the association between the at least one API of the set of APIs and the at least one operation of the set of operations. The status data 220 corresponds to one of a modified state value indicative of the modified state of the at least one portion of the application data 212 within the computational environment 210, an unmodified state value indicative of the unmodified state of the at least one portion of the application data 212 within the computational environment, and an absence value state indicative of the cache data 218 within the storage environment 216. By way of example, and not by limitation, the modified state value, the unmodified state value, and the absence state value correspond to “modified”, “unmodified”, and “absence”. By way of additional example, and not by limitation, the modified state value, the unmodified state value, and the absence state value correspond to “1”, “0”, and “−1”. For example, the computer system 202 is configured to determine the status data 220 corresponding to the modified state value based on the determination that the second identifier of the UPDATE API is present within the set of API identifiers. In an additional example, the computer system 202 is configured to determine the status data 220 corresponding to the unmodified state value based on the determination that the first identifier of the CREARE API is absent within the set of API identifiers. In an additional embodiment of the disclosure, the computer system 202 is configured to determine the presence of the log data 214 within the computational environment 210. Further, the computer system 202 is configured to determine the status data 220 corresponding to the absence state value based on a determination that log data 214 is present within the computational environment 210.

At 408, a determination is made whether the status data 220 is indicative of the absence of the cache data 218 within the storage environment 216 or not. In an embodiment of the disclosure, the computer system 202 is configured to determine whether the status data 220 is indicative of the absence of the cache data 218 within the storage environment 216 or not. In an embodiment of the disclosure, the computer system 202 is configured to determine whether the status data 220 is indicative of the absence of the cache data 218 within the storage environment 216 or not based on the reception of the request from the first user device 204. In various embodiments of the disclosure, the computer system 202 is configured to obtain the status data 220 from the change status module 314 based on the reception of the request from the first user device 204. In an embodiment of the disclosure, the computer system 202 is configured to determine that the status data 220 is indicative of the absence of the cache data 218 within the storage environment 216 based on a determination that the status data 220 corresponds to the absence state value. In an embodiment of the disclosure, the operations of the method proceed to 410 based on a determination that the status data 220 is indicative of the absence of the cache data 218 within the storage environment 216. Otherwise, the operations of the method proceed to 512 based on a determination that the status data 220 is indicative of the absence of the cache data 218 within the storage environment 216.

At 410, a second identifier determination operation is executed. In the second identifier determination operation, the computer system 202 is configured to determine a second identifier associated with the computational environment 210 based on the determination of the status data 220 is indicative of the presence of the cache data 218 within the storage environment 216. The second identifier associated with the computational environment 210 corresponds to a second file path of the computational environment 210. Examples of the second file path include, but are not limited to, a Windows environment file path, a Linux environment file path, a cloud storage file path, and a website uniform resource locator (URL). By way of example, and not by limitation, the window environment file path, the Linux environment file path, the cloud storage file path, and the website uniform resource locator (URL) correspond to
“C: \Users\Datafile.txt”,
“/home/user/Datafile.txt”,
“s3://my-bucket-user/Datafile.txt”, and
“http://www.example.com/Datafile”, respectively.

At 412, a second instructions generation operation is executed. In the second instructions generation operation, the computer system 202 is configured to generate a second set of instructions based on the second identifier. The second set of instructions is generated to retrieve the at least one portion of the application data 212. Examples of the second set of instructions include, but are not limited to, a type command for the window environment file path, a cat command for the Linux environment file path, an aws command for the cloud storage file path, and a curl command for the website URL. By way of example, and not by limitation, the type command, the cat command, the aws s3 command, and the curl command correspond to
“type C: \Users\Datafile.txt”, “cat/home/user/Datafile.txt”,
“aws s3://my-bucket-user/Datafile.txt”, and
“curl-0 http://www.example.com/Datafile”, respectively.

At 414, a second instructions execution operation is executed. In the second instructions execution operations, the computer system 202 is configured to execute the generated second set of instructions. In various embodiments of the disclosure, the computer system 202 is configured to execute the second set of instructions based on the generation of the second set of instructions. For example, the computer system 202 is configured to execute the type command within a Windows terminal. In an additional example, the computer system 202 is configured to execute the cat command within a Linux terminal. In yet additional example, the computer system 202 is configured to execute the website URL in the Windows terminal.

At 416, an application data retrieval operation is executed. In the application data retrieval operation, the computer system 202 is configured to retrieve the at least one portion of the application data 212 from the computational environment 210 based on the execution of the generated second set of instructions.

At 418, an application data output operation is executed. In the application data output operation, the computer system 202 is configured to output the retrieved at least one portion of the application data 212. In an embodiment of the disclosure, the computer system 202 is configured to output the status data 220 on the display screen 206 of the first user device 204. In an embodiment of the disclosure, the computer system 202 is configured to generate an audio alert via a set of speakers associated with the computer system 202. The audio alert is indicative of the output of the retrieved at least one portion of the application data 212.

At 420, a cache data generation operation is executed. In the cache data generation operation, the computer system 202 is configured to generate the cache data 218 identical to the at least one portion of the application data 212. Specifically, the computer system 202 is configured to generate the cache data 218 based on the retrieval of the at least one portion of the application data 212 from the computational environment 210.

At 422, a cache data storage operation is executed. In the cache data storage environment, the computer system 202 is configured to store the generated cache data 218 within the storage environment 216. In an embodiment of the disclosure, the computer system 202 is configured to store the cache data 218 based on the generation of the cache data 218.

At 424, a status data update operation is executed. In the status data update operation, the computer system 202 is configured to update the status data 220 based on the generation of the cache data 218. The updated status data is indicative of the unmodified state of the at least one portion of the application data 212 within the computational environment 210. The unmodified state of the at least one portion of the application data 212 indicates that the at least one portion of the application data 212 is unmodified within the computational environment 210 based on the set of operations executed on the at least one portion of the application data 212. In an embodiment of the disclosure, the computer system 202 is configured to update the absence state value to the unmodified state value. The unmodified state value is indicative of the unmodified state of the at least one portion of the application data 212 within the computational environment 210.

At 426, an updated status data output operation is executed. In the updated status data output operation, the computer system 202 is configured to output the updated status data. In an embodiment of the disclosure, the computer system 202 is configured to output the updated status data based on the updating of the status data 220. In an embodiment of the disclosure, the computer system 202 is configured to output the updated status data on a user interface associated with the computer system 202. In an embodiment of the disclosure, the computer system 202 is configured to generate an audio alert that is indicative of the updating of the status data 220. In an embodiment of the disclosure, the computer system 202 is configured to store the updated status data within the change status module 314.

At 428, a determination is made whether the status data 220 is indicative of the unmodified state of the at least one portion of the application data 212 within the computational environment 210 or not. In an embodiment of the disclosure, the computer system 202 is configured to determine whether the status data 220 is indicative of the unmodified state of the at least one portion of the application data 212 or not. In an embodiment of the disclosure, the computer system 202 is configured to determine whether the status data 220 is indicative of the unmodified state of the at least one portion of the application data 212 or not based on the reception of the request from the first user device 204. In various embodiments of the disclosure, the computer system 202 is configured to obtain the status data 220 from the change status module 314 based on the reception of the request from the first user device 204. In an embodiment of the disclosure, the computer system 202 is configured to determine that the status data 220 is indicative of the unmodified state of the at least one portion of the application data 212 based on a determination that the status data 220 corresponds to the unmodified state value. In an embodiment of disclosure, the operations of the method proceed to 430 based on a determination that the status data 220 is indicative of the unmodified state of the at least one portion of the application data 212 within the computational environment 210. Otherwise, the operations of the method proceed to 440 based on a determination that the status data 220 is indicative of the modified state of the at least one portion of the application data 212. The modified state of the at least one portion of the application data 212 indicates that the at least one portion of the application data 212 is modified within the computational environment 210. In an embodiment of the disclosure, the computer system 202 is configured to determine whether the status data 220 is indicative of the modified state of the at least one portion of the application data 212 or not based on the reception of the request from the first user device 204. In various embodiments of the disclosure, the computer system 202 is configured to obtain the status data 220 from the change status module 314 based on the reception of the request from the first user device 204. In an embodiment of the disclosure, the computer system 202 is configured to determine that the status data 220 is indicative of the modified state of the at least one portion of the application data 212 based on a determination that the status data 220 corresponds to the modified state value.

At 430, an identifier determination operation is executed. In the identifier determination operation, the computer system 202 is configured to an identifier associated with the storage environment 216 based on the determination that the status data 220 is indicative of the unmodified state of the at least one portion of the application data 212 within the computational environment 210. The identifier associated with the storage environment 216 corresponds to a file path of the storage environment 216. Examples of the first file path of the storage environment 216 include, but are not limited to, the window environment file path, the Linux environment file path, the cloud storage file path, and the website uniform resource locator (URL). By way of example, and not by limitation, the window environment file path, the Linux environment file path, the cloud storage file path, and the website uniform resource locator (URL) correspond to
“C: \Users\Data2file.txt”,
“/home/user/Datafile2.txt”,
“s3://my-bucket-user/Datafile2.txt”, and
“http://www.example.com/Datafile2”, respectively.

At 432, a third instructions generation operation is executed. In the third instructions generation operation, the computer system 202 is configured to a third set of instructions based on the identifier associated with the storage environment 216. In various embodiments of the disclosure, the computer system 202 is configured to execute the third set of instructions based on the generation of the third set of instructions. For example, the computer system 202 is configured to execute the type command within the Windows terminal. In an additional example, the computer system 202 is configured to execute the cat command within the Linux terminal. In yet additional example, the computer system 202 is configured to execute the website URL in the Windows terminal.

At 434, a third instructions execution operation is executed. In the third instructions execution operation, the computer system 202 is configured to the generated third set of instructions. In various embodiments of the disclosure, the computer system 202 is configured to execute the third set of instructions based on the generation of the third set of instructions. For example, the computer system 202 is configured to execute the type command within the Windows terminal. In an additional example, the computer system 202 is configured to execute the cat command within the Linux terminal. In yet additional example, the computer system 202 is configured to execute the website URL in the Windows terminal.

At 436, a cache data retrieval operation is executed. In the cache data retrieval operation, the computer system 202 is configured to retrieve the cache data 218 identical to the at least one portion of the application data 212 from the storage environment 216 based on the execution of the generated third set of instructions.

At 438, a cache data output operation is executed. In the cache data output operation, the computer system 202 is configured to output the retrieved cache data 218. In an embodiment of the disclosure, the computer system 202 is configured to output the cache data 218 based on the retrieval of the cache data 218 from the storage environment 216. In various embodiments of the disclosure, the computer system 202 is configured to output the cache data 218 on the display screen 206 of the first user device 204. In an embodiment of the disclosure, the computer system 202 is configured to generate an audio alert that is indicative of the output of the cache data 218.

At 440, a first identifier determination operation is executed. In the first identifier determination operation, the computer system 202 is configured to determine a first identifier associated with the computational environment 210 based on the determination that the status data 220 is indicative of the modified state of the at least one portion of the application data 212. The first identifier associated with the computational environment 210 corresponds to the first file path of the computational environment 210. Examples of the first file path include, but are not limited to, a Windows environment file path, a Linux environment file path, a cloud storage file path, and a website uniform resource locator (URL). By way of example, and not by limitation, the window environment file path, the Linux environment file path, the cloud storage file path, and the website URL correspond to
“C: \Users\Datafile3.txt”,
“/home/user/Datafile3.txt”,
“s3://my-bucket-user/Datafile3.txt”, and
“http://www.example.com/Datafile3”, respectively.

At 442, a first instructions generation operation is executed. In the first instructions generation operation, the computer system 202 is configured to generate the first set of instructions based on the first identifier. The first set of instructions is generated to retrieve the modified at least one portion of the application data 212. In various embodiments of the disclosure, the computer system 202 is configured to execute the first set of instructions based on the generation of the first set of instructions. For example, the computer system 202 is configured to execute the type command within the Windows terminal. In an additional example, the computer system 202 is configured to execute the cat command within the Linux terminal. In yet additional example, the computer system 202 is configured to execute the website URL in the Windows terminal.

At 444, a first instructions execution operation is executed. In the first instructions execution operation, the computer system 202 is configured to execute the generated first set of instructions. In various embodiments of the disclosure, the computer system 202 is configured to execute the second set of instructions based on the generation of the second set of instructions. For example, the computer system 202 is configured to execute the type command within a Windows terminal. In an additional example, the computer system 202 is configured to execute the cat command within a Linux terminal. In yet additional example, the computer system 202 is configured to execute the website URL in the Windows terminal.

At 446, a modified application data retrieval operation is executed. In the modified application data retrieval operation, the computer system 202 is configured to retrieve the modified at least one portion of the application data 212 from the computational environment 210 based on the execution of the generated first set of instructions.

At 448, a storage environment update operation is executed. In the storage environment update operation, the computer system 202 is configured to update the storage environment 216 with the modified at least one portion of the application data 212. In an embodiment of the disclosure, the computer system 202 is configured to delete the cache data 218 identical to the at least one portion of the application data 212 within the storage environment 216. Specifically, the computer system 202 is configured to control the first user device 204 to delete the cache data 218 from the storage environment 216. Further, the computer system 202 is configured to update the storage environment 216 with the modified at least one portion of the application data 212.

At 450, a modified application data transmission operation is executed. In the modified application data transmission operation, the computer system 202 is configured to transmit the modified at least one portion of the application data 212 to the first user device 204. In an embodiment of the disclosure, the computer system 202 is configured to transmit the at least one portion of the application data 212.

At 452 a modified application data output operation is executed. In the modified application data output operation, the computer system 202 is configured to output the modified at least one portion of the application data 212. In an embodiment of the disclosure, the computer system 202 is configured to output the modified at least one portion of the application data 212 based on the transmission of the modified at least one portion of the application data 212. In an embodiment of the disclosure, the computer system 202 is configured to output the modified at least one portion of the application data 212 on the user interface associated with the computer system 202. In various embodiments of the disclosure, the computer system 202 is configured to output the modified at least one portion of the application data 212 on the display screen 206 of the first user device 204. In an embodiment of the disclosure, the computer system 202 is configured to generate an audio alert that is indicative of the transmission of the modified at least one portion of the application data 212.

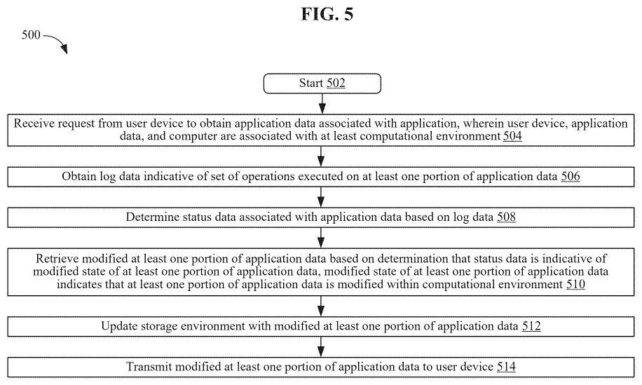

FIG. 5 is a diagram that illustrates a first flowchart 500 of a method for retrieval of application data from data sources, in accordance with an embodiment of the disclosure. FIG. 5 is explained in conjunction with elements from FIG. 1, FIG. 2, FIG. 3A, FIG. 3B, FIG. 4A, FIG. 4B, and FIG. 4C. The operations of the method illustrated by the first flowchart 500 may be executed by any computing system, for example, by the computer 102 of FIG. 1 or the computer system 202 of FIG. 2. The operations of the first flowchart 500 may start at 502.

At 504, the request from the first user device 204 is received to obtain the application data 212 associated with the application 208. In an embodiment of the disclosure, the computer system 202 is configured to receive the request from the first user device 204 to obtain the application data 212 associated the application 208. Details about the reception of the request are provided, for example, in FIGS. 4A, 4B, and 4C.

At 506, the log data 214 is obtained. The log data 214 is indicative of the set of operations executed on the at least one portion of the application data 212. In an embodiment of the disclosure, the computer system 202 is configured to obtain the log data 214 indicative of the set of operations executed on the at least one portion of the application data 212. Details about the acquisition of the log data 214 are provided, for example, in FIGS. 4A, 4B, and 4C.

At 508, the status data 220 associated with the application data 212 is determined based on the log data 214. In an embodiment of the disclosure, the computer system 202 is configured to determine the status data 220 associated with the application data 212 based on the log data 214. Details about the determination of the status data 220 are provided, for example, in FIGS. 4A, 4B, and 4C.

At 510, the modified at least one portion of the application data 212 is retrieved based on the determination that the status data is indicative of the modified state of the at least one portion of the application data 212. The modified state of the at least one portion of the application data 212 indicates that the at least one portion of the application data 212 is modified within the computational environment 210. The at least one portion of the application data 212 is modified based on the set of operations executed on the at least one portion of the application data 212. Details about the retrieval of the at least one portion of the application data 212 are provided, for example, in FIGS. 4A, 4B, and 4C.

At 512, the storage environment 216 is updated with the modified at least one portion of the application data 212. In an embodiment of the disclosure, the computer system 202 is configured to update the storage environment 216 with the modified at least one portion of the application data 212. Details about the updating of the storage environment 216 are provided, for example, in FIGS. 4A, 4B, and 4C.

At 514, the modified at least one portion of the application data 212 is transmitted to the first user device 204. In an embodiment of the disclosure, the computer system 202 is configured to transmit the modified at least one portion of the application data 212 to the first user device 204. Details about the transmission of the modified at least one portion of the application data 212 are provided, for example, in FIGS. 4A, 4B, and 4C.

While the above operations shown in FIG. 5 are described in a particular sequence, the operations may occur in variations to the sequence in accordance with various embodiments of the present disclosure. Further, details related to various operations of FIG. 5 which are already covered in the description related to FIG. 1, FIG. 2, FIG. 3A, FIG. 3B, FIG. 4A, FIG. 4B, and FIG. 4C is not discussed again in detail here for the sake of brevity.

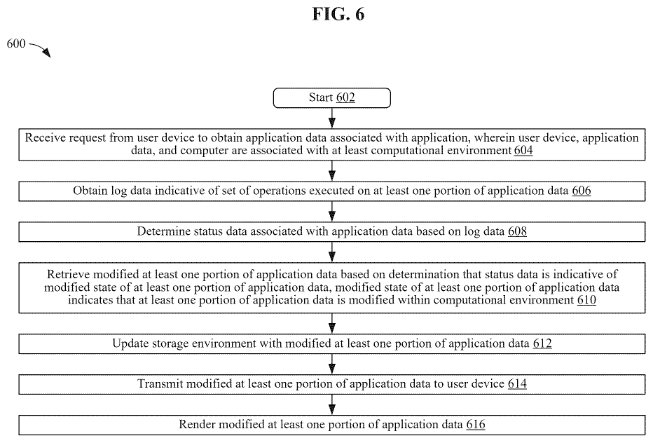

FIG. 6 is a diagram that illustrates a second flowchart 600 of a method for retrieval of application data from data sources, in accordance with an embodiment of the disclosure. FIG. 6 is explained in conjunction with elements from FIG. 1, FIG. 2, FIG. 3A, FIG. 3B, FIG. 4A, FIG. 4B, FIG. 4C, and FIG. 5. The operations of the method illustrated by the second flowchart 600 may be executed by any computing system, for example, by the computer 102 of FIG. 1 or the computer system 202 of FIG. 2. The operations of the second flowchart 600 may start at 602.

At 604, the request from the first user device 204 is received to obtain the application data 212 associated with the application 208. In an embodiment of the disclosure, the computer system 202 is configured to receive the request from the first user device 204 to obtain the application data 212 associated the application 208. Details about the reception of the request are provided, for example, in FIGS. 4A, 4B, and 4C.

At 606, the log data 214 is obtained. The log data 214 is indicative of the set of operations executed on the at least one portion of the application data 212. In an embodiment of the disclosure, the computer system 202 is configured to obtain the log data 214 indicative of the set of operations executed on the at least one portion of the application data 212. Details about the acquisition of the log data 214 are provided, for example, in FIGS. 4A, 4B, and 4C.

At 608, the status data 220 associated with the application data 212 is determined based on the log data 214. In an embodiment of the disclosure, the computer system 202 is configured to determine the status data 220 associated with the application data 212 based on the log data 214. Details about the determination of the status data 220 are provided, for example, in FIGS. 4A, 4B, and 4C.

At 610, the modified at least one portion of the application data 212 is retrieved based on the determination that the status data is indicative of the modified state of the at least one portion of the application data 212. The modified state of the at least one portion of the application data 212 indicates that the at least one portion of the application data 212 is modified within the computational environment 210. The at least one portion of the application data 212 is modified based on the set of operations executed on the at least one portion of the application data 212. Details about the retrieval of the at least one portion of the application data 212 are provided, for example, in FIGS. 4A, 4B, and 4C.

At 612, the storage environment 216 is updated with the modified at least one portion of the application data 212. In an embodiment of the disclosure, the computer system 202 is configured to update the storage environment 216 with the modified at least one portion of the application data 212. Details about the updating of the storage environment 216 are provided, for example, in FIGS. 4A, 4B, and 4C.

At 614, the modified at least one portion of the application data 212 is transmitted to the first user device 204. In an embodiment of the disclosure, the computer system 202 is configured to transmit the modified at least one portion of the application data 212 to the first user device 204. Details about the transmission of the modified at least one portion of the application data 212 are provided, for example, in FIG. 4A, FIG. 4B, and FIG. 4C.

At 616, the modified at least one portion of the application data 212 is rendered. In an embodiment of the disclosure, the computer system 202 is configured to render the modified at least one portion of the application data 212 to the first user device 204. Details about the rendering of the modified at least one portion of the application data 212 are provided, for example, in FIG. 4A, FIG. 4B, and FIG. 4C.

While the above operations shown in FIG. 6 are described in a particular sequence, the operations may occur in variations to the sequence in accordance with various embodiments of the present disclosure. Further, details related to various operations of FIG. 6 which are already covered in the description related to FIG. 1, FIG. 2, FIG. 3A, FIG. 3B, FIG. 4A, FIG. 4B, FIG. 4C, and FIG. 5 are not discussed again in detail here for the sake of brevity.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used

herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, a request from a user device to obtain application data associated with an application, wherein the user device, the application data, and the computer are associated with at least a computational environment;
obtaining, by the computer, log data indicative of a set of operations executed on at least one portion of the application data;
determining, by the computer, status data associated with the application data based on the log data;
retrieving, by the computer, modified at least one portion of the application data based on a determination that the status data is indicative of a modified state of the at least one portion of the application data, the modified state of the at least one portion of the application data indicates that the at least one portion of the application data is modified within the computational environment,
wherein the at least one portion of the application data is modified based on the set of operations executed on the at least one portion of the application data;
updating, by the computer, a storage environment with the modified at least one portion of the application data; and
transmitting, by the computer, the modified at least one portion of the application data to the user device.

2. The computer-implemented method of claim 1, further comprising:
determining, by the computer, a first identifier associated with the computational environment based on the determination that the status data is indicative of the modified state of the at least one portion of the application data;
generating, by the computer, a first set of instructions based on the first identifier, wherein the first set of instructions is generated to retrieve the modified at least one portion of the application data;
executing, by the computer, the generated first set of instructions; and
retrieving, by the computer, the modified at least one portion of the application data from the computational environment based on the execution of the generated first set of instructions.

3. The computer-implemented method of claim 1, further comprising:
determining, by the computer, that the status data is indicative of an absence of cache data within the storage environment, wherein the cache data is identical to the at least one portion of the application data;
retrieving, by the computer, the at least one portion of the application data from the computational environment based on the determination that the status data is indicative of the absence of the cache data within the storage environment; and
transmitting, by the computer, the retrieved at least one portion of the application data to the user device.

4. The computer-implemented method of claim 3, further comprising:
determining, by the computer, a second identifier associated with the computational environment based on the determination that the status data is indicative of the absence of the cache data within the storage environment;
generating, by the computer, a second set of instructions based on the second identifier, wherein the second set of instructions is generated to retrieve the at least one portion of the application data;
executing, by the computer, the generated second set of instructions; and
retrieving, by the computer, the at least one portion of the application data from the computational environment based on the execution of the generated second set of instructions.

5. The computer-implemented method of claim 4, further comprising:
generating, by the computer, the cache data identical to the at least one portion of the application data, based on the retrieval of the at least one portion of the application data from the computational environment; and
storing, by the computer, the generated cache data within the storage environment.

6. The computer-implemented method of claim 5, further comprising:
updating, by the computer, the status data based on the generation of the cache data, wherein:
the updated status data is indicative of an unmodified state of the at least one portion of the application data within the computational environment, and
the unmodified state of the at least one portion of the application data indicates that the at least one portion of the application data is unmodified within the computational environment based on the set of operations executed on the at least one portion of the application data; and
outputting, by the computer, the updated status data.

7. The computer-implemented method of claim 1, further comprising:
determining, by the computer, that the status data is indicative of an unmodified state of the at least one portion of the application data within the computational environment;
retrieving, by the computer, cache data identical to the at least one portion of the application data from the storage environment, based on the determination that the status data is indicative of the unmodified state of the at least one portion of the application data; and
transmitting, by the computer, the cache data to the user device.

8. The computer-implemented method of claim 7, further comprising:
determining, by the computer, an identifier associated with the storage environment based on the determination that the status data is indicative of the unmodified state of the at least one portion of the application data within the computational environment;
generating, by the computer, a third set of instructions based on the identifier associated with the storage environment;
executing, by the computer, the generated third set of instructions; and
retrieving, by the computer, the cache data identical to the at least one portion of the application data from the storage environment based on the execution of the generated third set of instructions.

9. The computer-implemented method of claim 1, further comprising:
obtaining, by the computer, the application data of the application, wherein the application data comprises at least application programming interface (API) data associated with a set of APIs of the application;
obtaining, by the computer, the log data associated with the set of operations based on the API data;
determining, by the computer, map data indicative of at least an association between at least one API of the set of APIs and at least one operation of the set of operations, based on the log data;
determining, by the computer, the status data based on the map data; and
outputting, by the computer, the status data.

10. The computer-implemented method of claim 1, wherein the log data comprises at least a timestamp associated with each operation of the set of operations, a type associated with each operation of the set of operations, an identifier associated with each operation of the set of operations, and a result associated with each operation of the set of operations.

11. A computer system, comprising:
a processor set;
one or more computer-readable storage media; and
program instructions stored on the one or more computer-readable storage media, the program instructions executable by the processor set to cause the processor set to:
receive a request from a user device to obtain application data associated with an application, wherein the user device, the application data, and a computer are associated with at least a computational environment;
obtain log data indicative of a set of operations executed on at least one portion of the application data;
determine status data associated with the application data based on the log data;
retrieve modified at least one portion of the application data based on a determination that the status data is indicative of a modified state of the at least one portion of the application data, the modified state of the at least one portion of the application data indicates that the at least one portion of the application data is modified within the computational environment,
wherein the at least one portion of the application data is modified based on the set of operations executed on the at least one portion of the application data;
update a storage environment with the modified at least one portion of the application data;
transmit the modified at least one portion of the application data to the user device; and
render the modified at least one portion of the application data.

12. The computer system of claim 11, wherein the program instructions further cause the processor set to:
determine a first identifier associated with the computational environment based on the determination that the status data is indicative of the modified state of the at least one portion of the application data;
generate a first set of instructions based on the first identifier, wherein the first set of instructions is generated to retrieve the modified at least one portion of the application data;
execute the generated first set of instructions; and
retrieve the modified at least one portion of the application data from the computational environment based on the execution of the generated first set of instructions.

13. The computer system of claim 11, wherein the program instructions further cause the processor set to:
determine that the status data is indicative of an absence of cache data within the storage environment, wherein the cache data is identical to the at least one portion of the application data;
retrieve the at least one portion of the application data from the computational environment based on the determination that the status data is indicative of the absence of the cache data within the storage environment; and
transmit the retrieved at least one portion of the application data to the user device.

14. The computer system of claim 13, wherein the program instructions further cause the processor set to:
determine a second identifier associated with the computational environment based on the determination that the status data is indicative of the absence of the cache data within the storage environment;
generate a second set of instructions based on the second identifier, wherein the second set of instructions is generated to retrieve the at least one portion of the application data;
execute the generated second set of instructions; and
retrieve the at least one portion of the application data from the computational environment based on the execution of the generated second set of instructions.

15. The computer system of claim 14, wherein the program instructions further cause the processor set to:
generate the cache data identical to the at least one portion of the application data based on the retrieval of the at least one portion of the application data from the computational environment; and
store the generated cache data within the storage environment.

16. The computer system of claim 15, wherein the program instructions further cause the processor set to:
update the status data based on the generation of the cache data, wherein:
the updated status data is indicative of an unmodified state of the at least one portion of the application data within the computational environment, and
the unmodified state of the at least one portion of the application data indicates that the at least one portion of the application data is unmodified within the computational environment based on the set of operations executed on the at least one portion of the application data; and
output the updated status data.

17. The computer system of claim 11, wherein the program instructions further cause the processor set to:
determine that the status data is indicative of an unmodified state of the at least one portion of the application data within the computational environment;
retrieve cache data identical to the at least one portion of the application data from the storage environment based on the determination that the status data is indicative of the unmodified state of the at least one portion of the application data; and
transmit the cache data to the user device.

18. The computer system of claim 17, wherein the program instructions further cause the processor set to:
determine an identifier associated with the storage environment based on the determination that the status data is indicative of the unmodified state of the at least one portion of the application data within the computational environment;
generate a third set of instructions based on the identifier associated with the storage environment;
execute the generated third set of instructions; and
retrieve the cache data identical to the at least one portion of the application data from the storage environment based on the execution of the generated third set of instructions.

19. The computer system of claim 11, wherein the program instructions further cause the processor set to:
obtain the application data of the application, wherein the application data comprises at least application programming interface (API) data associated with a set of APIs of the application;
obtain the log data associated with the set of operations based on the API data;
determine map data indicative of at least an association between at least one API of the set of APIs and at least one operation of the set of operations based on the log data;
determine the status data based on the map data; and
output the status data.

20. A computer program product for retrieval of application data from data sources, the computer program product comprising:
one or more computer-readable storage media; and
program instructions stored on the one or more computer-readable storage media to perform operations comprising:
receiving a request from a user device to obtain application data associated with an application, wherein the user device, the application data, and a computer are associated with at least a computational environment;
obtaining log data indicative of a set of operations executed on at least one portion of the application data;
determining status data associated with the application data based on the log data;
retrieving modified at least one portion of the application data based on a determination that the status data is indicative of a modified state of the at least one portion of the application data, the modified state of the at least one portion of the application data indicates that the at least one portion of the application data is modified within the computational environment,
wherein the at least one portion of the application data is modified based on the set of operations executed on the at least one portion of the application data;
updating a storage environment with the modified at least one portion of the application data; and
transmitting the modified at least one portion of the application data to the user device.
